(19) United States
(12) Patent Application Publication
(10) Pub. No.: US 2026/0208211 A1
(43) Pub. Date: Jul. 23, 2026

(54) TWO-PLANE FLUID DISCHARGE NOZZLE

(71) Applicant: MATTHEW SMENTKOWSKI, LINCOLN PARK, NJ (US)

(72) Inventor: MATTHEW SMENTKOWSKI, LINCOLN PARK, NJ (US)

(21) Appl. No.: 18/581,472

(22) Filed: Feb. 20, 2024

(51) Int. Cl. B05B 1/20; B05B 9/01; B05B 13/02

(52) U.S. Cl. CPC B05B 1/205; B05B 9/01; B05B 13/0278

(57) ABSTRACT

The two-plane fluid discharge nozzle is a spray nozzle. The two-plane fluid discharge nozzle is configured for use in cleaning the brink of a convex surface. The two-plane fluid discharge nozzle simultaneously cleans the two surfaces that form the brink. The two-plane fluid discharge nozzle simultaneously sprays water on the two surfaces that form the brink. The two-plane fluid discharge nozzle includes a manifold structure, a plurality of spray nozzles, and a want structure. The manifold structure forms a fluidic connection between the wand structure and the plurality of spray nozzles.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of spray guns. (B08B3/028)

### SUMMARY OF INVENTION

The two-plane fluid discharge nozzle is a spray nozzle. The two-plane fluid discharge nozzle is configured for use in cleaning the brink of a convex surface. The two-plane fluid discharge nozzle simultaneously cleans the two surfaces that form the brink. The two-plane fluid discharge nozzle simultaneously sprays water on the two surfaces that form the brink. The two-plane fluid discharge nozzle comprises a manifold structure, a plurality of spray nozzles, and a want structure. The manifold structure forms a fluidic connection between the wand structure and the plurality of spray nozzles.

These together with additional objects, features and advantages of the two-plane fluid discharge nozzle will be readily apparent to those of ordinary skill in the art upon reading the following detailed description of the presently preferred, but nonetheless illustrative, embodiments when taken in conjunction with the accompanying drawings.

In this respect, before explaining the current embodiments of the two-plane fluid discharge nozzle in detail, it is to be understood that the two-plane fluid discharge nozzle is not limited in its applications to the details of construction and arrangements of the components set forth in the following description of illustration. Those skilled in the art will appreciate that the concept of this disclosure may be readily utilized as a basis for the design of other structures, methods, and systems for carrying out the several purposes of the two-plane fluid discharge nozzle.

It is therefore important that the claims be regarded as including such equivalent construction insofar as they do not depart from the spirit and scope of the two-plane fluid discharge nozzle. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a side view of an embodiment of the disclosure.

FIG. 3 is a front view of an embodiment of the disclosure.

FIG. 4 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

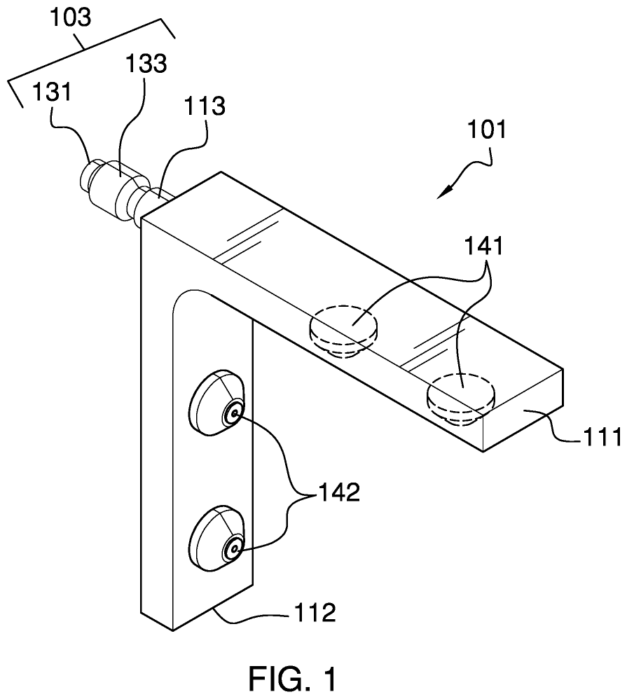

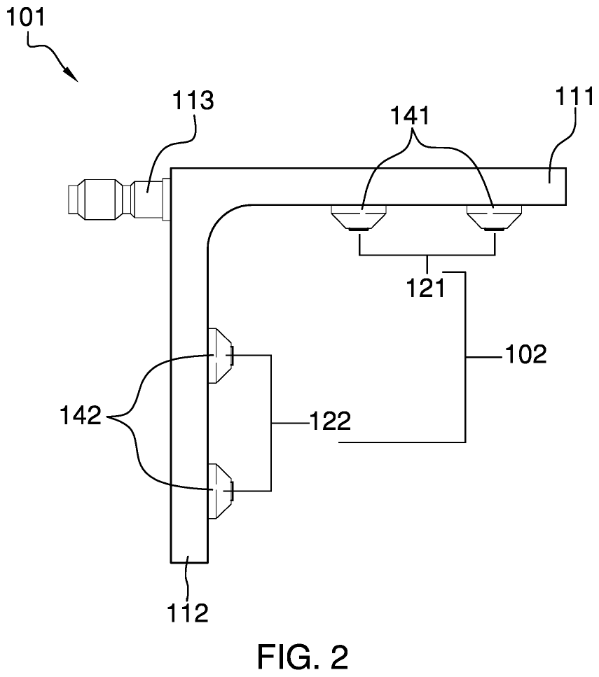

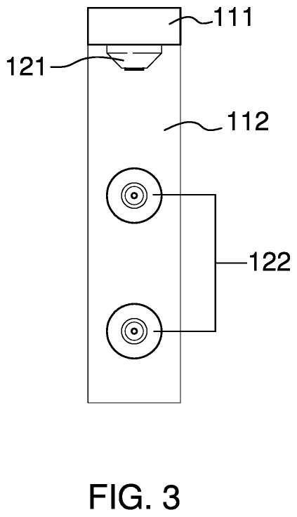

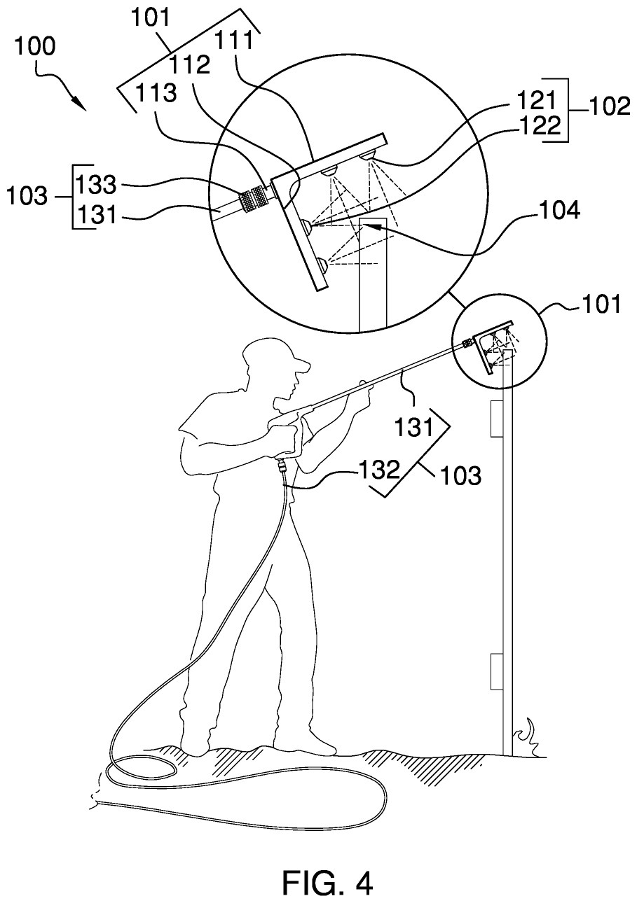

Detailed reference will now be made to one or more potential embodiments of the disclosure, which are illustrated in FIGS. 1 through 4.

The two-plane fluid discharge nozzle 100 (hereinafter invention) is a spray nozzle. The invention 100 is configured for use in cleaning the brink 104 of a convex surface. The invention 100 simultaneously cleans the two surfaces that form the brink 104. The invention 100 simultaneously sprays water on the two surfaces that form the brink 104. The invention 100 comprises a manifold structure 101, a plurality of spray nozzles 102, and a wand structure 103. The manifold structure 101 forms a fluidic connection between the wand structure 103 and the plurality of spray nozzles 102.

The manifold structure 101 is a manifold. The manifold structure 101 is a fluid transport structure. £ The manifold structure 101 forms a fluidic connection between the wand structure 103 and the plurality of spray nozzles 102. The manifold structure 101 transports water that is received under pressure from the wand structure 103 to the plurality of spray nozzles 102. The manifold structure 101 discharges the received water through the plurality of spray nozzles 102 on to the brink of the convex surface.

The manifold structure 101 is an offset composite structure. The manifold structure 101 is a hollow structure. The manifold structure 101 forms two water flow paths. The manifold structure 101 discharges water from the plurality of spray nozzles 102 in two directions. A cant is formed between the two water discharge directions provided through the manifold structure 101. The cant formed in the two water flow directions are selected such that the water discharged from the manifold structure 101 will simultaneously clean the surfaces forming the brink of the convex surface.

The manifold structure 101 comprises a first arm 111, a second arm 112, and an intake port 113.

The first arm 111 is a prism shaped structure. The first arm 111 is a hollow structure. The first arm 111 forms a fluid transport structure. The first arm 111 forms a fluidic connection with the intake port 113. The first arm 111 transports water that is received under pressure from the first arm 111 to a first sub-plurality of spray nozzles 121 selected from the plurality of spray nozzles 102.

The first arm 111 further comprises a first plurality of discharge ports 141. Each discharge port selected from the first plurality of discharge ports 141 is a fluid port that is formed through the lateral face of the prism structure of the first arm 111. The first plurality of discharge ports 141 forms the fluid transport structure that discharges water under pressure from the first arm 111 into the spray nozzle selected from the first sub-plurality of spray nozzles 121 that is mounted in the selected discharge port. The first plurality of discharge ports 141 are formed in the lateral face of the first arm 111 such that the centers of each discharge port selected from the first plurality of discharge ports 141 form a line.

The second arm 112 is a prism shaped structure. The second arm 112 is a hollow structure. The second arm 112 forms a fluid transport structure. The second arm 112 forms a fluidic connection with the intake port 113. The second arm 112 transports water that is received under pressure from the second arm 112 to a second sub-plurality of spray nozzles 122 selected from the plurality of spray nozzles 102. A cant is formed between the center axis of the prism structure of the first arm 111 of the manifold structure 101 and the center axis of the prism structure of the second arm 112 of the manifold structure 101.

The second arm 112 further comprises a second plurality of discharge ports 142. Each discharge port selected from the second plurality of discharge ports 142 is a fluid port that is formed through the lateral face of the prism structure of the second arm 112. The second plurality of discharge ports 142 forms the fluid transport structure that discharges water under pressure from the second arm 112 into the spray nozzle selected from the second sub-plurality of spray nozzles 122 that is mounted in the selected discharge port. The second plurality of discharge ports 142 are formed in the lateral face of the second arm 112 such that the centers of each discharge port selected from the second plurality of discharge ports 142 form a line.

The intake port 113 is a fluid port. The intake port 113 forms a fluidic connection with the wand structure 103. The intake port 113 receives water under pressure from the wand structure 103. The intake port 113 discharges a portion of the received water into the first arm 111. The intake port 113 discharges the balance of the received water into the second arm 112.

The plurality of spray nozzles 102 forms the structure that converts the water discharged from the manifold structure 101 into a spray. Each spray nozzle selected from the spray nozzle selected from the plurality of spray nozzles 102 forms a spray nozzle. The plurality of spray nozzles 102 comprises a first sub-plurality of spray nozzles 121 and a second sub-plurality of spray nozzles 122.

The first sub-plurality of spray nozzles 121 is a first subset of spray nozzles selected from the plurality of spray nozzles 102. The first sub-plurality of spray nozzles 121 control the water discharge from the first arm 111 of the manifold structure 101. Each spray nozzle selected from the first sub-plurality of spray nozzles 121 mounts in a discharge port selected from the first plurality of discharge ports 141. Each spray nozzle selected from the first sub-plurality of spray nozzles 121 is positioned within its selected discharge port such that the water under pressure is discharged radially away from the center axis of the first arm 111 on to the brink of the convex surface.

The second sub-plurality of spray nozzles 122 is a second subset of spray nozzles selected from the plurality of spray nozzles 102. The second sub-plurality of spray nozzles 122 control the water discharge from the second arm 112 of the manifold structure 101. Each spray nozzle selected from the second sub-plurality of spray nozzles 122 mounts in a discharge port selected from the second plurality of discharge ports 142. Each spray nozzle selected from the second sub-plurality of spray nozzles 122 is positioned within its selected discharge port such that the water under pressure is discharged radially away from the center axis of the second arm 112 on to the brink of the convex surface.

The wand structure 103 forms a handle used to carry and use the invention 100. The wand structure 103 forms a water transport structure that transports water from an externally provided source of pressurized water to the manifold structure 101. The wand structure 103 forms a detachable fluidic connection with the manifold structure 101. The wand structure 103 is an extension apparatus. The wand structure 103 extends the reach between manifold structure 101 and an individual using the invention 100. The wand structure 103 comprises an extension structure 131, a hose structure 132, and a quick connect fitting 133.

The extension structure 131 is a prism shaped structure. The extension structure 131 forms a tube. The extension structure 131 forms the reach between the hose structure 132 and the intake port 113 of the manifold structure 101. The extension structure 131 forms a fluidic connection between the hose structure 132 and the intake port 113. The extension structure 131 transports water that is received under pressure from the hose structure 132 to the intake port 113.

The hose structure 132 is a hose. The hose structure 132 forms a water transport structure that receives water under pressure from an externally provided water source. The hose structure 132 forms a fluidic connection with an open congruent end of the tubular structure of the extension structure 131.

The hose structure 132 discharges the water received from the externally provided water source into the extension structure 131.

The quick connect fitting 133 is a fitting. The quick connect fitting 133 forms a detachable fluidic connection between the intake port 113 of the manifold structure 101 and the open congruent end of the tubular structure of the extension structure 131 that is distal from the hose structure 132. The quick connect fitting 133 discharges the water received from the extension structure 131 into the manifold structure 101 through the intake port 113.

The following definitions were used in this disclosure:
Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.
Brink: As used in this disclosure, a brink refers to the edge or line formed by the intersection of a first plane or surface and a second plane or surface wherein a cant exists between the first plane or surface and the second plane or surface.
Cant: As used in this disclosure, a cant is an angular deviation from one or more reference lines (or planes) such as a vertical line (or plane) or a horizontal line (or plane).
Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.
Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.
Composite Prism: As used in this disclosure, a composite prism refers to a structure that is formed from a plurality of structures selected from the group consisting of a prism structure, a pyramid structure, and a spherical structure. The plurality of selected structures may or may not be truncated or bifurcated. The plurality of prism structures are joined together such that the center axes of each of the plurality of structures are aligned. The congruent ends of any two structures selected from the group consisting of a prism structure and a pyramid structure need not be geometrically similar.
Concave: As used in this disclosure, concave is used to describe: 1) a surface that resembles the interior surface of a sphere; or, 2) a function with a curvature structure wherein a chord that connects any two points of the function will be lesser than (graphically below) or equal to the value of the function at any point along the chord.
Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.
Convex: As used in this disclosure, convex is used to describe: 1) a surface that resembles the outer surface of a sphere; or, 2) a function with a curvature structure wherein a chord that connects any two points of the function will be greater than (graphically above) or equal to the value of the function at any point along the chord.
Correspond: As used in this disclosure, the term correspond is used as a comparison between two or more objects wherein one or more properties shared by the two or more objects match, agree, or align within acceptable manufacturing tolerances.
Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.
Environment: As used in this disclosure, an environment refers to the physical conditions surrounding an object. The term environment is often limited to the physical conditions that the object interacts with.
Extension Apparatus: As used in this disclosure, an extension apparatus is a mechanical structure that is used to extend or bridge the reach between any two objects.
Extension Structure: As used in this disclosure, an extension structure is an inert physical structure that is used to extend or bridge the reach between any two objects.
Exterior: As used in this disclosure, the exterior is used as a relational term that implies that an object is not contained within the boundary of a structure or a space.
Fitting: As used in this disclosure, a fitting is a component that attaches a first object to a second object. The fitting is used to form a fluidic connection between the first object and the second object.
Flow: As used in this disclosure, a flow refers to the passage of a fluid past a fixed point. This definition considers bulk solid materials as capable of flow.
Fluid: As used in this disclosure, a fluid refers to a state of matter wherein the matter is capable of flow and takes the shape of a container it is placed within. The term fluid commonly refers to a liquid or a gas.
Fluid Impermeable: As used in this disclosure, the term fluid impermeable refers to: a) the ability of a structure to not allow a fluid to pass through the structure; or, b) the ability of a material not absorb through the exterior surfaces of the material a fluid that the material is immersed in or exposed to.
Fluidic Connection: As used in this disclosure, a fluidic connection refers to a tubular structure that transports a fluid from a first object to a second object. Methods to design and use a fluidic connections are well-known and documented in the mechanical, chemical, and plumbing arts.
Fluid Network: As used in this disclosure, a fluid network refers to a transport structure that: a) receives a fluid into the fluid network; b) transports the fluid through a series of pipes, valves, and manifolds; and, c) discharges the fluid from the fluid network.
Form Factor: As used in this disclosure, the term form factor refers to the size and shape of an object.
Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1. By the term essentially geometrically similar is meant that the primary shapes of two objects are geometrically similar except that there are functional items (such as fastening devices) associated with the primary shape may not maintain the ratio for geometric similarity. By the term roughly geometrically similar is meant that the form factors between the primary shape of the two objects can vary by a factor of up to 10% when the two objects are normalized to be roughly geometrically identical.
Gas: As used in this disclosure, a gas refers to a state (phase) of matter that is fluid and that fills the volume of the structure that contains it. Stated differently, the volume of a gas always equals the volume of its container.
Grip: As used in this disclosure, a grip is an accommodation formed on or within an object that allows the object to be grasped or manipulated by a hand.
Handle: As used in this disclosure, a handle is an object by which a tool, object, or door is held or manipulated with the hand.
Hose: As used in this disclosure, a hose is a flexible hollow prism-shaped device that is used for transporting liquids and gases. When referring to a hose in this disclosure, the terms inner dimension and outer dimension are used as they would be used by those skilled in the plumbing arts.
Interior: As used in this disclosure, the interior is used as a relational term that implies that an object is contained within the boundary of a structure or a space.
Liquid: As used in this disclosure, a liquid refers to a state (phase) of matter that is fluid and that maintains, for a given pressure, a fixed volume that is independent of the volume of the container.
Manifold: As used in this disclosure, a manifold is a pipe, chamber, or fluid network having several ports through which one or more substances are gathered or distributed.
Negative Space: As used in this disclosure, negative space is a method of defining an object through the use of open or empty space as the definition of the object itself, or, through the use of open or empty space to describe the boundaries of an object.
Nozzle: As used in this disclosure, a nozzle is a device that receives fluid under pressure and releases the fluid in a controlled manner into a reservoir structure or an environment. An intake nozzle refers to a device that forms a negative pressure within the nozzle structure such that the intake nozzle draws a fluid through the intake nozzle into a reservoir structure.
One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.
Quick Connect Fitting: As used in this disclosure, a quick connect fitting is a coupling that is used in fluid flow applications to quickly connect or disconnect two lines or two objects through which fluids will flow. Connections or disconnections are intended to be done by hand without the use of tools. Quick connect fittings readily and commercially available and methods for their selection and use well known and documented in the mechanical, chemical, and plumbing arts.
Pan: As used in this disclosure, a pan is a hollow and prism-shaped containment structure. The pan has a single open face. The open face of the pan is often, but not always, the superior face of the pan. The open face is a surface selected from the group consisting of: a) a congruent end of the prism structure that forms the pan; and, b) a lateral face of the prism structure that forms the pan. A semi-enclosed pan refers to a pan wherein the closed end of prism structure of the pan and/or a portion of the closed lateral faces of the pan are open.
Perimeter: As used in this disclosure, a perimeter is one or more curved or straight lines that bounds an enclosed area on a plane or surface. The perimeter of a circle is commonly referred to as a circumference.
Phase: As used in this disclosure, phase refers to the state of the form of matter. The common states of matter are solid, liquid, gas, and plasma.
Primary Shape: As used in this disclosure, the primary shape refers to a description of the rough overall geometric shape of an object that is assembled from multiple components or surfaces. The term essential primary shape is used to indicate the exclusion of functional items that are attached to the structure of the primary shape.
Primary Structure: As used in this disclosure, a primary structure refers to the component of an object that the other components attach to. The primary structure is also called the base structure.
Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.
Offset Composite Prism: As used in this disclosure, an offset composite prism structure is a non-Euclidean structure. The shape of the offset composite prism structure is reasonably approximated by a plurality of prism structures. The shape of the offset composite prism structure is formed by joining the congruent end of a first prism structure is joined to the congruent end of a second structure such that the center axis of the first prism structure forms a cant with the center axis of the second prism structure.
Reach: As used in this disclosure, reach refers to a span of distance between any two objects.
Solid: As used in this disclosure, a solid refers to a state (phase) of matter that: 1) has a fixed volume; and, 2) does not flow.
Spray Nozzle: As used in this disclosure, a spray nozzle is a device that receives liquid under pressure and disperses that liquid into the atmosphere as a spray.
Tube: As used in this disclosure, a tube is a hollow prism-shaped device formed with two open congruent ends. The tube is used for transporting liquids (including bulk solids) and gases. The line that connects the center of the first congruent face of the prism to the center of the second congruent face of the prism is referred to as the center axis of the tube or the centerline of the tube. When two tubes share the same centerline they are said to be aligned. When the centerlines of two tubes are perpendicular to each other, the tubes are said to be perpendicular to each other. In this disclosure, the terms inner dimensions of a tube and outer dimensions of a tube are used as they would be used by those skilled in the plumbing arts.
Water: As used in this disclosure, water (CAS 7732-18-5) is a molecule comprising two hydrogen atoms and one oxygen molecule. The phase of water at normal temperature and pressure is liquid. As used in this disclosure, the definition of water is expanded to include dilute water-based solutions of salts and ionic structures using water as the solvent. Water in a gas phase is often referred to as steam. Water in a solid phase is often referred to as ice. Snow refers to a bulk solid form of ice.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A two-plane fluid discharge nozzle comprising
a manifold structure, a plurality of spray nozzles, and a wand structure;
wherein the manifold structure forms a fluidic connection between the wand structure and the plurality of spray nozzles;
wherein the two-plane fluid discharge nozzle is configured for use in cleaning the brink of a convex surface;
wherein the two-plane fluid discharge nozzle simultaneously cleans the surfaces that form the brink;
wherein the manifold structure comprises a first arm, a second arm, and an intake port;
wherein the first arm forms a fluidic connection with the intake port;
wherein the second arm forms a fluidic connection with the intake port;
wherein the intake port is a fluid port that forms a fluidic connection with the wand structure;
wherein the intake port receives water under pressure from the wand structure;
wherein the intake port discharges a portion of the received water into the first arm;
wherein the intake port discharges the balance of the received water into the second arm.

2. The two-plane fluid discharge nozzle according to claim 1
wherein the two-plane fluid discharge nozzle simultaneously sprays water on the surfaces that form the brink.

3. The two-plane fluid discharge nozzle according to claim 2
wherein the manifold structure is a manifold;
wherein the manifold structure is a fluid transport structure;
wherein the manifold structure forms a fluidic connection between the wand structure and the plurality of spray nozzles;
wherein the manifold structure transports water that is received under pressure from the wand structure to the plurality of spray nozzles;
wherein the manifold structure discharges the received water through the plurality of spray nozzles.

4. The two-plane fluid discharge nozzle according to claim 3
wherein the manifold structure is an offset composite structure;
wherein the manifold structure is a hollow structure;
wherein the manifold structure forms two water flow paths;
wherein the manifold structure discharges water from the plurality of spray nozzles in two directions;
wherein a cant is formed between the two water discharge directions provided through the manifold structure;
wherein the cant formed in the two water flow directions is selected such that the water discharged from the manifold structure will simultaneously clean the surfaces forming the brink of the convex surface.

5. The two-plane fluid discharge nozzle according to claim 4
wherein the plurality of spray nozzles forms a structure that converts the water discharged from the manifold structure into a spray;
wherein each spray nozzle selected from the plurality of spray nozzles forms a spray nozzle.

6. The two-plane fluid discharge nozzle according to claim 5
wherein the wand structure forms a water transport structure that transports water from an externally provided source of pressurized water to the manifold structure;
wherein the wand structure forms a detachable fluidic connection with the manifold structure;
wherein the wand structure is an extension apparatus;
wherein the wand structure extends the reach between the manifold structure and an individual using the two-plane fluid discharge nozzle.

7. (canceled)

8. The two-plane fluid discharge nozzle according to claim 6
wherein the plurality of spray nozzles comprises a first sub-plurality of spray nozzles and a second sub-plurality of spray nozzles;
wherein the first sub-plurality of spray nozzles is a first subset of spray nozzles selected from the plurality of spray nozzles;
wherein the second sub-plurality of spray nozzles is a second subset of spray nozzles selected from the plurality of spray nozzles.

9. The two-plane fluid discharge nozzle according to claim 8
wherein the first arm is a prism shaped structure;
wherein the first arm is a hollow structure;
wherein the first arm forms a fluid transport structure;
wherein the first arm transports water that is received under pressure from the first arm to a the first sub-plurality of spray nozzles selected from the plurality of spray nozzles.

10. The two-plane fluid discharge nozzle according to claim 9
wherein the second arm is a prism shaped structure;
wherein the second arm is a hollow structure;
wherein the second arm forms a fluid transport structure;
wherein the second arm transports water that is received under pressure from the second arm to the second sub-plurality of spray nozzles selected from the plurality of spray nozzles;
wherein a cant is formed between the center axis of the prism structure of the first arm of the manifold structure and the center axis of the prism structure of the second arm of the manifold structure.

11. (canceled)

12. The two-plane fluid discharge nozzle according to claim 10
wherein the first arm further comprises a first plurality of discharge ports;
wherein each discharge port selected from the first plurality of discharge ports is a fluid port that is formed through the lateral face of the prism shaped structure of the first arm;
wherein the first plurality of discharge ports are formed in the lateral face of the first arm such that the centers of each discharge port selected from the first plurality of discharge ports form a line;
wherein the second arm further comprises a second plurality of discharge ports;
wherein each discharge port selected from the second plurality of discharge ports is a fluid port that is formed through the lateral face of the prism shaped structure of the second arm;
wherein the second plurality of discharge ports are formed in the lateral face of the second arm such that the centers of each discharge port selected from the second plurality of discharge ports form a line.

13. The two-plane fluid discharge nozzle according to claim 12
wherein the first sub-plurality of spray nozzles control the water discharge from the first arm of the manifold structure;
wherein each spray nozzle selected from the first sub-plurality of spray nozzles mounts in a discharge port selected from the first plurality of discharge ports;
wherein each spray nozzle selected from the first sub-plurality of spray nozzles is positioned within its selected discharge port such that the water under pressure is discharged radially away from the center axis of the first arm on to the brink of the convex surface;
wherein the second sub-plurality of spray nozzles control the water discharge from the second arm of the manifold structure;
wherein each spray nozzle selected from the second sub-plurality of spray nozzles mounts in a discharge port selected from the second plurality of discharge ports;
wherein each spray nozzle selected from the second sub-plurality of spray nozzles is positioned within its selected discharge port such that the water under pressure is discharged radially away from the center axis of the second arm on to the brink of the convex surface.

14. The two-plane fluid discharge nozzle according to claim 13
wherein the wand structure comprises an extension structure, a hose structure, and a quick connect fitting;
wherein the extension structure forms a tube;
wherein the extension structure forms the reach between the hose structure and the intake port of the manifold structure;
wherein the extension structure forms a fluidic connection between the hose structure and the intake port;
wherein the extension structure transports water that is received under pressure from the hose structure to the intake port;
wherein the hose structure is a hose;
wherein the hose structure forms a water transport structure that receives water under pressure from an externally provided water source;
wherein the hose structure forms a fluidic connection with an open congruent end of the tubular structure of the extension structure;
wherein the hose structure discharges the water received from the externally provided water source into the extension structure;
wherein the quick connect fitting is a fitting;
wherein the quick connect fitting forms a detachable fluidic connection between the intake port of the manifold structure and the open congruent end of the tubular structure of the extension structure that is distal from the hose structure;
wherein the quick connect fitting discharges the water received from the extension structure into the manifold structure through the intake port.
